(19) United States
(12) Patent Application Publication
(10) Pub. No.: US 2011/0102825 A1
(43) Pub. Date: May 5, 2011

(54) IMAGE PROCESSING DEVICE HAVING A PLURALITY OF CONTROL UNITS

(75) Inventor: Akihiro YAMADA, Nagoya-shi (JP)

(73) Assignee: BROTHER KOGYO KABUSHIKI KAISHA, Nagoya-shi (JP)

(21) Appl. No.: 12/852,412

(22) Filed: Aug. 6, 2010

(30) Foreign Application Priority Data
Oct. 29, 2009 (JP) 2009-249226

(51) Int. Cl. G06F 3/12

(52) U.S. Cl. 358/1.13

(57) ABSTRACT

A plurality of control units is configured to control a executing unit to execute each function in one of a plurality of performance modes. Each control unit is configured to be capable of switching an operational state thereof between a running state and a halt state. A plurality of combinations of the operation states for the control units are different from one performance mode to another. At least one control unit of the plurality of control units is in the running state in each performance mode. The plurality of performance modes have different performance levels. A selecting unit selects one of the plurality of performance modes based on the function corresponding to the at least one instruction. The plurality of control units controls the executing unit to execute the function corresponding to the at least one instruction in the one of the plurality of performance modes.

### CROSS REFERENCE TO RELATED APPLICATION

This application claims priority from Japanese Patent Application No. 2009-249226 filed Oct. 29, 2009. The entire content of the priority application is incorporated herein by reference.

### TECHNICAL FIELD

The present invention relates to an image processing device. More specifically, the present invention relates to an image processing device with a plurality of control units.

### BACKGROUND

It has been conventionally well-known an image processing device capable of executing various functions for processing image data, such as a scanner function, a copy function, a PC print function, and a facsimile communication function. In such a conventional image processing device, a plurality of control units including a CPU is provided.

Japanese Patent Application Publication No. 8-101609 discloses an image processing device including a main control unit and a sub-control unit. The main control unit controls each of various units, such as a printer unit, and the sub-control unit controls an interface for communicating with external devices. During a power-saving mode, the main control unit is placed in a halt state, and only the sub-control unit is in a running state. The configuration reduces power consumption in the power saving mode.

### SUMMARY

However, in the image processing device described above, processes executed by each of the main control unit and the sub-control unit are normally predetermined and fixed. In certain circumstances, such processes are not efficiently executed, and improvement is required.

In view of the foregoing, it is an object of the present invention to provide an image processing device capable of executing functions efficiently by using a plurality of control units.

In order to attain the above and other objects, the present invention provides an image processing device including an executing unit, a receiving unit, a plurality of control units, and a selecting unit. The executing unit is configured to execute a plurality of functions for processing image data. The receiving unit is configured to receive at least one instruction for executing corresponding function. The plurality of control units is configured to control the executing unit to execute each function in one of a plurality of performance modes. Each control unit is configured to be capable of switching an operational state thereof between a running state and a halt state. A plurality of combinations of the operation states for the control units are different from one performance mode to another. At least one control unit of the plurality of control units is in the running state in each performance mode. The plurality of performance modes have different performance levels. The selecting unit selects one of the plurality of performance modes based on the function corresponding to the at least one instruction. The plurality of control units controls the executing unit to execute the function corresponding to the at least one instruction in the one of the plurality of performance modes.

### BRIEF DESCRIPTION OF THE DRAWINGS

The particular features and advantages of the invention as well as other objects will become apparent from the following description taken in connection with the accompanying drawings, in which:

FIG. 1 is a block diagram showing electrical configuration of an image processing system according to a first embodiment of the present invention;

FIG. 2 is a flowchart illustrating steps in a job execution process according to the first embodiment of the present invention;

FIG. 3 is a table showing correspondence relationship between functions, input devices for inputting executing instructions, and control units according to the first embodiment of the present invention;

FIG. 4 is a flowchart illustrating steps in a job execution process according to a second embodiment of the present invention;

FIG. 5 is a table showing correspondence relationship between functions, load levels, and control units according to the second embodiment of the present invention; and

FIG. 6 is a flowchart illustrating steps in a job execution process according to a third embodiment of the present invention.

### DETAILED DESCRIPTION

Image processing systems according to embodiments of the present invention will be described while referring to the accompanying drawings wherein like parts and components are designated by the same reference numerals to avoid duplicating description.

### First Embodiment

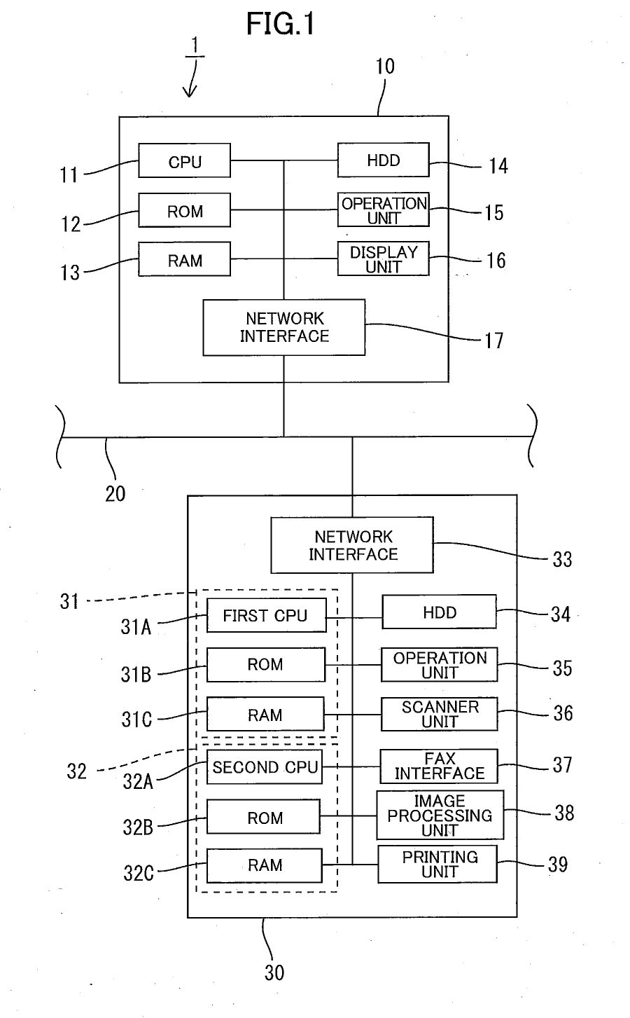

First, an image processing system 1 according to a first embodiment will be described while referring to FIGS. 1 to 3.

(Electrical Configuration of Image Processing System)

As shown in FIG. 1, the image processing system 1 includes a terminal device 10 (as an example of an external device, such as a personal computer) and a printer 30 (as an example of an image processing device).

The terminal device 10 includes a CPU 11, a ROM 12, a RAM 13, a hard disk drive (HDD) 14, an operation unit 15, a display unit 16, and a network interface 17. Although not shown in the drawings, the operation unit 15 includes a keyboard and a pointing device, and the display unit 16 includes a display. The network interface 17 is connected to a communication line 20. The HDD 14 stores various programs including an operation system (OS), an application software for generating image data to be printed, and a printer driver for controlling the printer 30. The CPU 11 performs overall control of the terminal device 10 based on a program read from the ROM 12 while storing processed results in the RAM 13 and the HDD 14.

The printer 30 is a multifunction device capable of executing a plurality of functions including a PC print function, a copy function, and a scanner function. The printer 30 includes a first control unit 31 and a second control unit 32. The first control unit 31 includes a first CPU 31A, a ROM 31B, and a RAM 31C. The second control unit 32 includes a second CPU 32A, a ROM 32B, and a RAM 32C.

The printer 30 further includes various devices including a network interface 33, an HDD 34, an operation unit 35, a scanner unit 36, a facsimile interface 37, an image processing unit 38, and a printing unit 39.

Each of the ROM 31B and the ROM 32B stores various programs for controlling the printer 30, such as a job execution process described later. Each of the first CPU 31A and the second CPU 32A performs overall control of the printer 30 based on a program read from the respective ROMs 31B and 32B while storing processed results into the respective RAMs 31C and 32C.

The first control unit 31 has a higher performance level than the second control unit 32, and consumes more power than the second control unit 32. More specifically, the operating frequency of the first CPU 31A is 400 MHz, for example, and the operating frequency of the second CPU 32A is 50 MHz, for example. Also, the RAM 31C has a larger memory capacity than the RAM 32C. Accordingly, the first control unit 31 is capable of processing at a higher speed compared to the second control unit 32.

Each of the first control unit 31 and the second control unit 32 is capable of switching its operational state between a running state and a halt state (switching between on and off of a power source) through a power source controller (not shown). By switching each operational state of the first control unit 31 and the second control unit 32 between the running state and the halt state, the first control unit 31 and the second control unit 32 are capable of selecting one of three performance modes A, B, and C of the printer 30 to execute the functions and other processes.

In the performance mode A, only the second control unit 32 is in the running state, and the first control unit 31 is in the halt state (sleep state). In the performance mode B, only the first control unit 31 is in the running state, and the second control unit 32 is in the halt state. In the performance mode C, the first control unit 31 and the second control unit 32 are both in the running state. As described above, the first control unit 31 has a performance level higher than the second control unit 32. Accordingly, the performance mode C has a performance level higher than that of the performance mode B, and the performance mode B has a performance level higher than that of the performance mode A.

Note that the first control unit 31 and the second control unit 32 can operate each of the devices in the running state, but cannot access the HDD 34 or the like in the halt state. The first control unit 31 and the second control unit 32 in the halt state can only detect predetermined signals (activation interrupt signal, for example) from the control unit in the running state or from external devices.

The network interface 33 is connected to an external device such as the terminal device 10 through the communication line 20, enabling data communication therebetween. Although not shown in the drawings, the operation unit 35 includes various buttons through which a user inputs various instructions including an executing instruction for each job (function). The operation unit 35 also includes a display unit (a liquid crystal display panel, for example) and a lamp, and is capable of displaying various setting screens and operation status.

The scanner unit 36 obtains scanned data by scanning an original (not shown). The facsimile interface 37 transmits facsimile data to or receives facsimile data from a remote device such as a facsimile device (not shown) through a telephone line.

The image processing unit 38 is configured by an ASIC, and processes various image data. For example, in the image processing unit 38, compensation, color conversion, or the like are performed with respect to the image data. The image data may be scanned data obtained by the scanner unit 36, print data received at the network interface 33, or the like.

The printing unit 39 forms an image on a recording sheet (paper sheet, OHP sheet, or the like) based on the image data in an electrophotographic method or an inkjet method, for example.

(Job Execution Process)

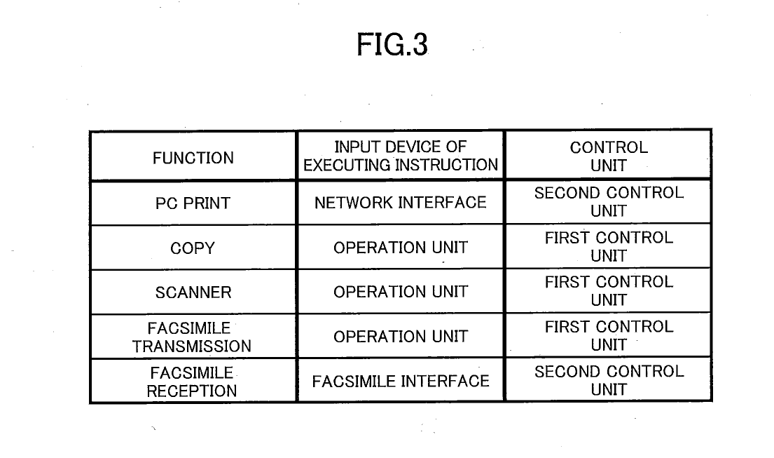

As shown in FIG. 3, the printer 30 is capable of executing a plurality of functions including a PC print function, a copy function, a scanner function, a facsimile transmission function, and a facsimile reception function. Each of the functions can be executed based on an executing instruction inputted from any one of the operation unit 35, the network interface 33, or the facsimile interface 37. Note that the executing instruction referred to here is an instruction for executing at least one of the plurality of functions described above. In the first embodiment, an input device for inputting an executing instruction is predetermined and fixed for each function.

The PC print function is executed upon receiving through the network interface 33 an executing instruction transmitted from the terminal device 10. In the PC print function, the network interface 33 receives print data from the terminal device 10, and the image processing unit 38 processes the print data (expands the print data into bitmap data, for example), and the printing unit 39 forms an image on a recording sheet based on the processed print data.

The copy function is executed based on an executing instruction inputted from the operation unit 35. In the copy function, the scanner unit 36 obtains scanned data by scanning an original, the image processing unit 38 processes the scanned data, and the printing unit 39 prints an image on a recording sheet based on the scanned data.

The scanner function is executed based on an executing instruction inputted from the operation unit 35. In the scanner function, the scanner unit 36 obtains scanned data by scanning an original, the image processing unit 38 processes the scanned data, and then, the image data is stored in a storage unit, such as the HDD 34 of the printer 30 and the HDD 14 of the terminal device 10, designated by the operation unit 35.

The facsimile transmission function is executed based on an executing instruction inputted from the operation unit 35. In the facsimile transmission function, the scanner unit 36 obtains scanned data by scanning an original, the image processing unit 38 processes the scanned data, and then, the facsimile interface 37 transmits facsimile data based on the scanned data to a designated destination.

The facsimile reception function is executed based on an executing instruction (facsimile reception request) received by the facsimile interface 37. In the facsimile reception function, the facsimile interface 37 receives facsimile data, and stores the same in the HDD 34.

Each of the first control unit 31 and the second control unit 32 is capable of executing a job reception process for receiving the executing instruction for each job (function) described above. When the second control unit 32 is in the running state, that is, when the performance mode A or performance mode C has been selected, the second control unit 32 executes the job reception process. When the second control unit 32 is in the halt state, that is, when the performance mode B has been selected, the first control unit 31 executes the job reception process. In the job reception process, each of the first control unit 31 and the second control unit 32 awaits an input of an executing instruction for a job from each of the operation unit 35, the network interface 33, and the facsimile interface 37. When an executing instruction for a job is inputted, the job is registered in a queue.

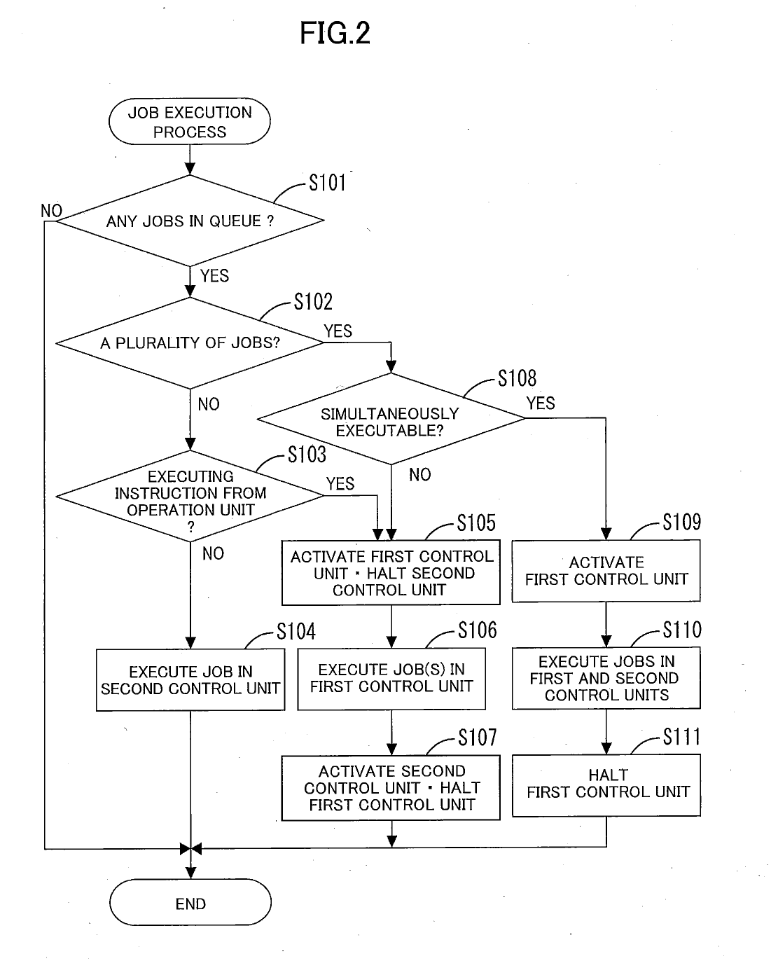

When a main power source of the printer 30 is switched on, a predetermined activation process is executed. In the predetermined activation process, the performance mode A in which only the second control unit 32 is in the running state is selected. When the predetermined activation process has been completed, the second control unit 32 starts a job execution process shown in FIG. 2 simultaneously with the job reception process. In this job execution process, the second control unit 32 selects one of the three performance modes A to C according to a function to be executed to execute the registered job in the queue when a job has been registered in the queue based on the job reception process.

When starting the job execution process, in S101 the second control unit 32 determines whether or not any jobs have been registered in the queue. If no job has been registered in the queue (S101: No), the second control unit 32 ends the job execution process. When no job has been registered in the queue (that is, no function has been executed), the second control unit 32 executes a stand-by process. In the stand-by process, the second control unit 32 repeatedly determines on a regular basis whether or not any jobs have been registered in the queue, and waits for a job to be registered in the queue. This stand-by process is executed on the second control unit 32 while the first control unit 31 is in the halt state. That is, the stand-by process is executed in the performance mode A whose performance level is the lowest.

If any jobs have been registered in the queue (S101: Yes), in S102 the second control unit 32 determines whether or not a plurality of jobs has been registered in the queue. Note that a job that has been registered in the queue at the time when a determination is made in S101 is regarded as a job to be processed in this job execution process. If only a single job has been registered in the queue (S102: No), in S103 the second control unit 32 determines whether or not the executing instruction for the registered job has been inputted from the operation unit 35. If the executing instruction has been inputted not from the operation unit 35 but from the network interface 33 or the facsimile interface 37 (S103: No), that is, the executing instruction is either for the PC print function or for the facsimile reception function, in S104 the second control unit 32 executes the job registered in the queue. Then, the second control unit 32 deletes the job, which has been executed, from the queue, and ends the job execution process.

If the executing instruction for the registered job has been inputted from the operation unit 35 (S103: Yes), that is, the executing instruction is for any one of the copy function, the scanner function, or the facsimile transmission function, in S105 the performance mode is switched as described below.

The second control unit 32 firstly activates the first control unit 31 to write in the RAM 31C necessary data, such as contents of the job. The first control unit 31 takes over the job execution process currently executed under the control of the second control unit 32. Upon taking over the job execution process, the first control unit 31 halts the second control unit 32. As a result, the performance mode is switched from the performance mode A to the performance mode B.

Subsequently, in S106 the first control unit 31 executes the registered job. After the first control unit 31 deletes the job, which had been executed, from the queue, the first control unit 31 activates the second control unit 32 to write in the RAM 32C data necessary for the second control unit 32, so that the job execution process currently executed under the control of the first control unit 31 returns to the second control unit 32. Upon taking over the job execution process from the first control unit 31, in S107 the second control unit 32 halts the first control unit 31. As a result, the performance mode is switched from the performance mode B to the performance mode A. Then, the second control unit 32 ends the job execution process.

As described above, in the job execution process, in case a single job has been registered in the queue, the performance mode B in which only the first control unit 31 is in the running state is selected if the executing instruction for the job is inputted from the operation unit 35, and the performance mode A in which only the second control unit 32 is in the running state is selected if the executing instruction for the job is inputted either from the network interface 33 or from the facsimile interface 37. Accordingly, a job (function) whose executing instruction is inputted directly from the operation unit 35 is executed in a performance mode of higher performance level, compared to a job whose executing instruction is inputted from the network interface 33 or the facsimile interface 37.

Note that, in the job execution process, a job which has been registered in the queue at the time of executing S101 is regarded as a job to be processed. A job which is registered in the queue after having executed S101 is not regarded as a job to be processed. Accordingly, if a job is registered in the queue while the job execution process is being executed, the job will be executed in the next job execution process.

A plurality of jobs has been registered in the queue (S102: Yes), in S108 the second control unit 32 determines whether or not there are any simultaneously executable jobs in the plurality of jobs. The simultaneously executable jobs indicates more than one job that correspond to functions executable simultaneously with each other, such as the PC print function and the scanner function, and the copy function and the facsimile reception function.

If there are no simultaneously executable jobs in the jobs registered in the queue (S108: No), the second control unit 32 advances to S105. In S105 the second control unit 32 switches the performance mode to the performance mode B in which only the first control unit 31 is in the running state. In S106 the first control unit 31 sequentially executes one by one the plurality of jobs registered in the queue, and then, brings the performance mode back to the performance mode A in which only the second control unit 32 is in the running state (S107).

If there are any simultaneously executable jobs (S108: Yes), in S109 the second control unit 32 activates the first control unit 31 to switch the performance mode to the performance mode C in which the first control unit 31 and the second control unit 32 are both in the running state. Subsequently, in S110 both of the first control unit 31 and the second control unit 32 execute each of the jobs to be processed in cooperation with each other. Here, the first control unit 31 and the second control unit 32 share a job for a single function and execute the shared job. Further, the first control unit 31 and the second control unit 32 simultaneously execute more than one simultaneously executable job. When the first control unit 31 and the second control unit 12 simultaneously execute more than one job, the first control unit 31 may execute a function corresponding to one job while the second control unit 32 may execute a function corresponding to another job.

When all the jobs to be processed have been executed, in S111 the second control unit 32 halts the first control unit 31 and brings the performance mode back to the performance mode A. Then, the second control unit 32 ends the job execution process.

As described above, in the job executing process, if more than one job to be processed has been registered in the queue, compared with a case where only a single job to be processed has been registered in the queue (an executing instruction for the job is inputted from the network interface 33 or the facsimile interface 37), the jobs are executed in the performance mode B or the performance mode C which has a higher performance level than the performance mode A. If more than one simultaneously executable job to be processed has been registered in the queue, compared with a case where only a single job to be processed has been registered in the queue, the jobs are executed in the performance mode C whose performance level is the highest.

### Effect of the First Embodiment

As described above, according to the above embodiment, by switching the operational state of at least one of the first control unit 31 and the second control unit 32, the first control unit 31 and the second control unit 32 are capable of executing functions in the three performance modes of different performance levels. The first control unit 31 and the second control unit 32 select one of the three performance modes based on the functions to be executed and execute the functions. As described above, the first control unit 31 and the second control unit 32 select one of the three performance modes of different performance level according to a function to be executed, thereby enhancing their control capabilities efficiently.

If an executing instruction for a job is inputted from the operation unit 35, it seems more likely that a user is waiting for the job to be completed in front of the printer 30. If this is the case, compared with a case where an executing instruction for a job is inputted from the network interface 33 or the facsimile interface 37, a performance mode of higher performance level is selected to execute a function. Accordingly, waiting time for a user can be shortened.

The first control unit 31 and the second control unit 32 are capable of simultaneously executing more than one function. As the number of functions that the first control unit 31 and the second control unit 32 simultaneously execute is greater, a performance mode of higher performance level is selected by the first control unit 31 and the second control unit 32. Hence, since a performance mode of higher performance level is selected by the first control unit 31 and the second control unit 32 with increasing the number of functions that the first control unit 31 and the 32 simultaneously execute increases, processing time can be shortened regardless of load increase.

As the number of executing instructions (jobs) that have not been executed is greater, a performance mode of higher performance level is selected by the first control unit 31 and the second control unit 32. Accordingly, a processing speed can be increased.

The first control unit 31 and the second control unit 32 select a performance mode of lowest performance level when executing the stand-by process in which each of the network interface 33, the operation unit 35, and the facsimile interface 37 waits for an executing instruction for a job while no function has been executed. Accordingly, power consumption can be reduced.

### Second Embodiment

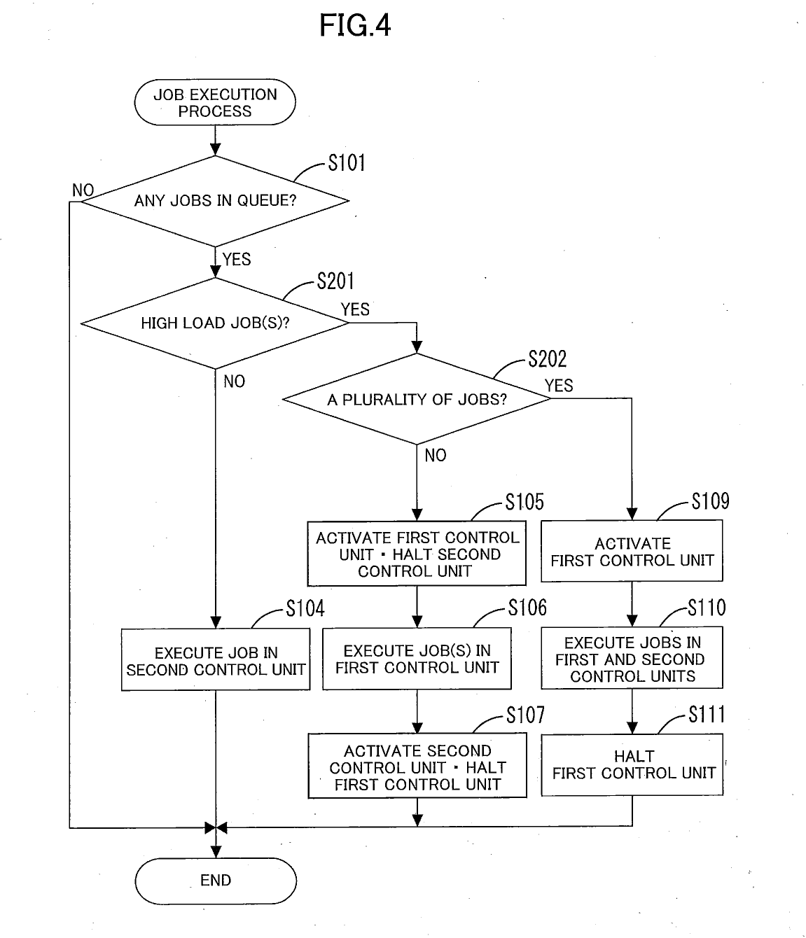

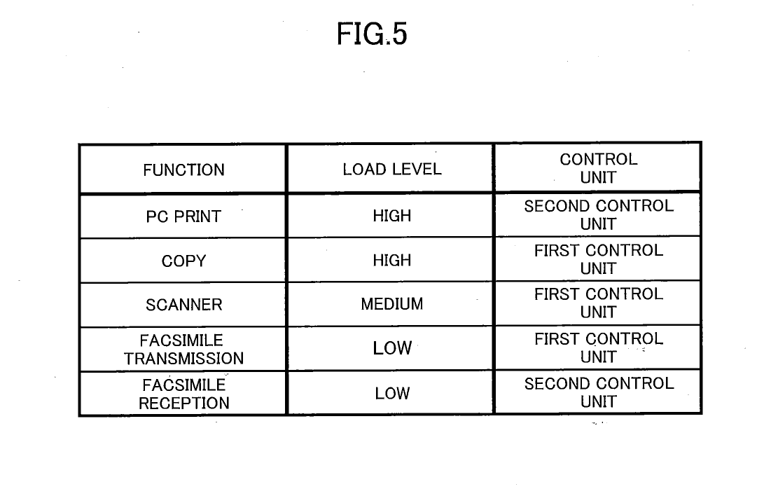

Next, a second embodiment of the present invention will be described while referring to FIGS. 4 and 5. A job execution process shown in FIG. 4 partially differs from the job execution process shown in FIG. 2. Since steps S101, S104, S105, S106, S107, S109, S110, and S111 in FIG. 4 are the same as those in FIG. 2, description thereof will be omitted. The configuration of the printer 30 according to the second embodiment is the same as that of the printer 30 according to the first embodiment.

As shown in FIG. 4, if any jobs have been registered in the queue (S101: Yes), in S201 the second control unit 32 determines whether or not the job(s) registered in the queue includes any jobs of high load level (that is, any jobs for executing the PC print function and/or the copy function). Here, as shown in FIG. 5, in the second embodiment, one of three load levels is assigned to each function according to a load applied to the first control unit 31 or the second control unit 32 in executing each function. These load levels include a low load level, a medium load level, a high load level. As shown in FIG. 5, the load level in executing each of the PC print function and the copy function is high because these functions require the printing unit 39 of a relatively high operating frequency to operate, the load level in executing the scanner function is medium because the function require only devices of relatively medium operating frequencies, and the load level in executing each of the facsimile transmission function and the facsimile reception function is low because these functions require only devices of relatively low operating frequencies.

If the job(s) registered in the queue includes no job of high load level (S201: No), in S104 the second control unit 32 executes the job(s) registered in the queue while maintaining the performance mode A. If the job(s) registered in the queue includes any jobs of high load level (S201: Yes), in S202 the second control unit 32 further determines whether or not a plurality of jobs to be processed have been registered in the queue.

If only a single job to be processed has been registered in the queue (S202: No), in S105 the second control unit 32 switches the performance mode to the performance mode B in which only the first control unit 31 is in the running state, and in S106 the first control unit 31 executes the registered job. If a plurality of jobs to be processed have been registered in the queue (S202: Yes), in S109 the second control unit 32 switches the performance mode to the performance mode C to activate the first control unit 31. Then, in S110 each of the first control unit 31 and the second control unit 32 execute the plurality of jobs in cooperation with each other.

As described above, according to the second embodiment, as a load of a function to be executed is higher, a performance mode of higher performance level is selected by the first control unit 31 and the second control unit 32. Hence, if a function of high load level is executed, a performance mode of high performance level is selected. Accordingly, processing time can be shortened. Further, if a function of lower load level is executed, a performance mode of lower performance level is selected. Accordingly, power consumption can be reduced.

If there are a plurality of executing instructions for jobs which have not been executed, the first control unit 31 and the second control unit 32 select a performance mode of performance level suited for a function of highest load level among functions to be executed based on the executing instructions. That is, if the plurality of executing instructions for jobs which have not been executed includes an executing instruction for a job of high load level, the performance mode B or C is selected. Provided that the plurality of executing instructions for jobs which have not been executed includes both of an executing instruction for a job of high load level and an executing instruction for a job of low load level, if a performance mode of performance level suited for a job of low load level is selected to execute all the jobs to be processed, it may take extremely long to process these jobs. It may also take time to switch the performance mode between the performance mode of performance level suited for the job of low load level and the performance mode of performance level suited for the job of high load level. In the second embodiment, when a plurality of functions are executed based on a plurality of executing instructions, a performance mode of performance level suited for a function of, highest load level is selected. Accordingly, without switching the selected performance mode to another in the course of executing functions, the functions can be executed in a shorter time.

### Third Embodiment

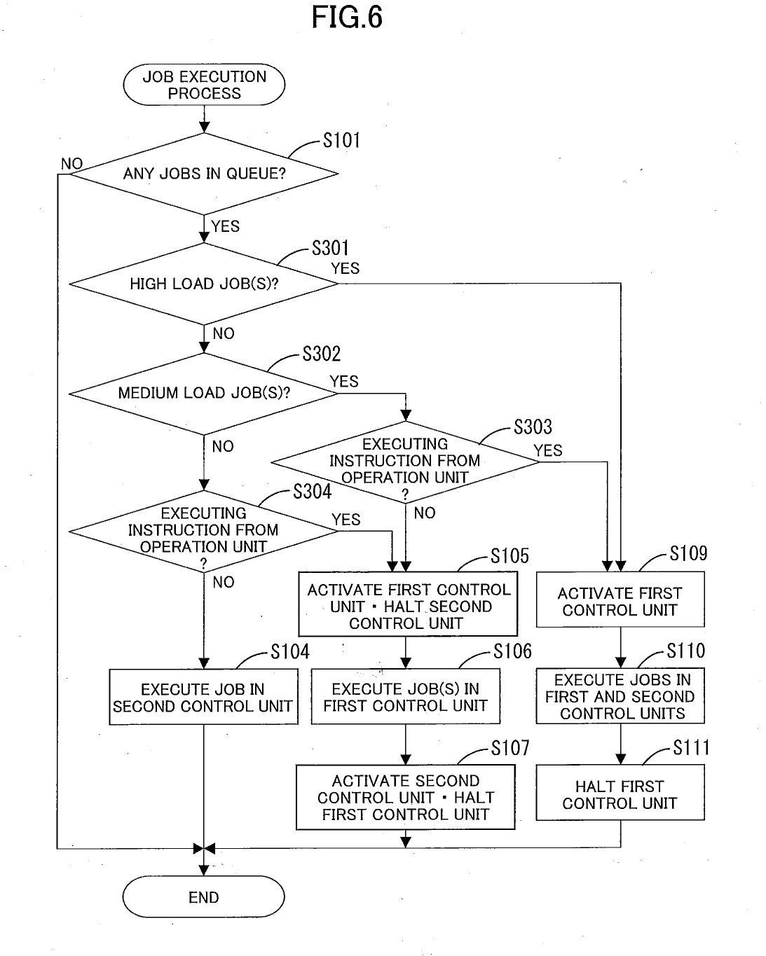

Next, a third embodiment of the present invention will be described while referring to FIG. 6. A job execution process shown in FIG. 6 partially differs from the job execution process shown in FIG. 2. Since steps S101, S104, S105, S106, S107, S109, S110, and S111 in FIG. 6 is the same as those in FIG. 2, description thereof will be omitted. The configuration of the printer 30 according to the third embodiment is the same as that of the printer 30 according to the first embodiment.

Note that, in the third embodiment, the input device for inputting the executing instruction for each function is not predetermined or fixed. For example, the executing instruction for executing each of the scanner function and the facsimile transmission function may be inputted from the terminal device 10 or from the operation unit 35.

As shown in FIG. 6, if any jobs have been registered in the queue (S101: Yes), in S301 the second control unit 32 determines whether or not the job(s) registered in the queue includes any jobs of high load level. Note that, here, in the same manner as the second embodiment, one of the three load levels, low, medium and high, is assigned to each function.

If the job(s) registered in the queue includes any jobs of high load level (S301: Yes), in S109 the second control unit 32 switches the performance mode to the performance mode C in which the first control unit 31 and the second control unit 32 are both in the running state. Then, in S110, both of the first control unit 31 and the second control unit 32 execute the job(s) to be processed in cooperation with each other. If the job(s) registered in the queue includes no job of high load level (S301: No), in S302 the second control unit 32 further determines whether or not the job(s) registered in the queue includes any jobs of medium load level.

If the job(s) registered in the queue includes any jobs of medium load level (S302: Yes), in S303 the second control unit 32 determines whether or not the job(s) registered in the queue includes any jobs whose executing instructions are inputted from the operation unit 35. If the job(s) registered in the queue includes no job whose executing instruction is inputted from the operation unit 35 (S303: No), in S105 the second control unit 32 switches the performance mode to the performance mode B in which only the first control unit 31 is in the running state. Then, in S106 the first control unit 31 executes the job(s) registered in the queue. If the job(s) registered in the queue includes any jobs whose executing instructions are inputted from the operation unit 35 (S303: Yes), in S109 the second control unit 32 switches the performance mode to the performance mode C in which the first control unit 31 and the second control unit 32 are both in the running state. Then, in S110 both of the first control unit 31 and the second control unit 32 execute the job(s) registered in the queue.

If the job(s) registered in the queue includes no job of medium load level (S302: No), in S304 the second control unit 32 determines whether or not the job(s) registered in the queue includes any jobs whose executing instructions are inputted from the operation unit 35. If the job(s) registered in the queue includes no job whose executing instruction is inputted from the operation unit 35 (S304: No), in S104 the second control unit 32 executes the job(s) registered in the queue while maintaining the performance mode A in which only the second control unit 32 is in the running state. If the job(s) registered in the queue includes any jobs whose executing instructions are inputted from the operation unit 35 (S304: Yes), in S105 the second control unit 32 switches the performance mode to the performance mode B in which only the first control unit 31 is in the running state. Then, in S106 the first control unit 31 executes the job(s) registered in the queue.

As described above, according to the third embodiment, if an executing instruction for a job (function) is inputted from the operation unit 35, compared with a case where an executing instruction is inputted from the network interface 33 or the facsimile interface 37, a performance mode of higher performance level is selected to execute the function. Accordingly, waiting time for the user can be shortened.

As a load of a function to be executed is higher, a performance mode of higher performance level is selected by the first control unit 31 and the second control unit 32. Hence, if a function of high load level is executed, a performance mode of high performance level is selected. Accordingly, processing time can be shortened. Further, if a function of low load level is executed, a performance mode of low performance level is selected. Accordingly, power consumption can be reduced.

If there are a plurality of executing instructions for jobs which have not been executed, the first control unit 31 and the second control unit 32 select a performance mode of performance level suited for a function of highest load level among functions to be executed based on the executing instructions. Hence, without switching the selected performance mode to another in the course of executing a function, the function can be executed in a shorter time.

### MODIFICATIONS

While the present invention has been described in detail with reference to the embodiments thereof, it would be apparent to those skilled in the art that various changes and modifications may be made therein without departing from the spirit of the invention.

(1) In the above-described embodiments, the first control unit 31 and the second control unit 32 include the ROM 31B and the RAM 31C, and the ROM 32B and the RAM 32C, respectively. However, each of the first control unit 31 and the second control unit 32 may includes either a ROM or a RAM, as long as each of the first CPU 31A and the second control unit 32 includes a CPU. Further, each of the first control unit 31 and the second control unit 32 may not include a ROM and a RAM. Alternatively, a ROM and a RAM may be separately provided from each of the first control unit 31 and the second control unit 32, and the first control unit 31 and the second control unit 32 may share a ROM and a RAM. Further, each of the first control unit 31 and the second control unit 32 may include an ASIC and other components.

(2) In the above-described embodiments, all the functions are executable in any of the three performance modes. However, at least one of the functions may be executable in a plurality of performance modes.

(3) In the above-described embodiments, the printer 30 has the two control units (31, 32). However, the printer 30 may have three or more control units. In the above-described embodiments, the printer 30 has the three performance modes of different performance levels. However, only two, or four or more performance modes may be available.

(4) In the above-described embodiments, the printer 30 is capable of executing the five functions. However, at least two functions may be executed by the printer 30. Five or more functions may be executed by the printer 30. Further, the present invention is applicable to an image processing device capable of executing various functions other than those described above. For example, the present invention is also applicable to a device capable of executing an e-mail function in which an e-mail attached with image data obtained by scanning an original is transmitted through a network interface.

Further, as a print function, in addition to the above-described PC print function, a direct print function may be available if the printer 30 includes a connection unit capable of connecting an external storage medium such as a USB memory. In the direct print function, the printing unit 39 prints data read from the external storage medium.

The present invention is also applicable to a device capable of executing a scan-to-memory function as a scanner function. In the scan-to-memory function, data obtained by scanning an original is written into an external storage medium such as a USB memory.

The printer 30 may execute, as a facsimile function, a PC-FAX function and a FAX print function. In the PC-FAX function, the printer 30 transmits through the facsimile interface 37 data received from a computer, for example. In the FAX print function, the printing unit 39 prints facsimile data received through the facsimile interface 37, for example.

(5) Conditions for selecting one of the three performance modes in the above-described embodiments can be changed appropriately. For example, S202 in FIG. 4 may be replaced with S103 in FIG. 2 so that the performance mode is switched according to the input device of the executing instruction. Alternatively, S202 in FIG. 4 is replaced with S108 in FIG. 2 so that the performance mode is switched based on the number of functions to be simultaneously executed. Further, S303 and S304 in FIG. 5 may be deleted, so that the performance mode is selected based on only the load level of the function to be executed.

(6) In the above-described second embodiment, the second control unit 32 switches the performance mode between two modes, according to the load level of the job (function) to be executed. In the above-described third embodiment, the second control unit 32 switches the performance mode between three modes, according to the load level of the job (function) to be executed. However, the performance mode may be switched between four or more modes according to the load level of the function to be executed.

(7) In the above-described first embodiment, the second control unit 32 switches the performance mode between two modes according to whether the number of the function to be simultaneously executed is one or more than one. However, the performance mode may be switched between three or more modes according to the number of the functions to be simultaneously executed.

(8) In the above-described first and second embodiments, the second control unit 32 switches the performance mode between two modes according to whether the number of the executing instructions (jobs) which have not been executed is one or more than one. However, the performance mode may be switched between three or more modes according to the number of the unexecuted executing instruction.

What is claimed is:

1. An image processing device comprising:
an executing unit that is configured to execute a plurality of functions for processing image data;
a receiving unit that is configured to receive at least one instruction for executing corresponding function; and
a plurality of control units that is configured to control the executing unit to execute each function in one of a plurality of performance modes, each control unit being configured to be capable of switching an operational state thereof between a running state and a halt state, a plurality of combinations of the operation states for the control units being different from one performance mode to another, at least one control unit of the plurality of control units being in the running state in each performance mode, the plurality of performance modes having different performance levels;
a selecting unit that selects one of the plurality of performance modes based on the function corresponding to the at least one instruction, the plurality of control units controlling the executing unit to execute the function corresponding to the at least one instruction in the one of the plurality of performance modes.

2. The image processing device according to claim 1, wherein the receiving unit comprises an operation unit through which a user is capable of inputting an instruction and a communication unit that is configured to receive an instruction transmitted from an external device,
wherein the selecting unit selects one performance mode from the plurality of performance modes when executing a function whose instruction is inputted through the operation unit,
wherein the selecting unit selects another performance mode from the plurality of performance modes when executing a function whose instruction is inputted through the communication unit, a performance level of the one performance mode being higher than that of the another performance mode.

3. The image processing device according to claim 2, wherein the plurality of functions includes a copy function which is executed based on an instruction inputted through the operation unit and in which image data is obtained by scanning an original and an image is printed on a recording medium based on the scanned image data, and a print function which is executed based on an instruction inputted through the communication unit and in which an image is printed on a recording medium based on image data,
wherein the selecting unit selects the one performance mode when executing the copy function, and
wherein the selecting unit selects the another performance mode when executing the print function.

4. The image processing device according to claim 1, wherein as a load in executing the instructed function is higher, the selecting unit selects a performance mode of higher performance level from the plurality of performance modes.

5. The image processing device according to claim 4, wherein the plurality of functions includes a print function in which an image is printed on a recording medium based on image data, and a facsimile function in which facsimile data is received and transmitted, a load in executing the print function being higher than that of the facsimile function, and
wherein the selecting unit selects one performance mode in the plurality of performance modes when executing the print function,
wherein the selecting unit selects another performance mode in the plurality of performance modes when executing the facsimile function, a performance level of the one performance mode being higher than that of the another performance mode.

6. The image processing device according to claim 1, wherein the selecting unit selects a performance mode from the plurality of performance modes when the receiving unit receives a plurality of instructions, a performance level of the selected performance mode being suited for a function that has highest load level among the functions corresponding to the received instructions.

7. The image processing device according to claim 1, wherein the plurality of control units is configured to control the executing unit to simultaneously execute more than one functions in the plurality of functions, and
wherein as the number of functions that the plurality of control units simultaneously execute is greater, the selecting unit selects a performance mode of higher performance level from the plurality of performance modes.

8. The image processing device according to claim 1, wherein as the number of instructions whose functions has not been executed is greater, the selecting unit selects a performance mode of higher performance level from the plurality of performance modes.

9. The image processing device according to claim 1, wherein the plurality of control units execute a stand-by process while the plurality of control units fails to control the executing unit and the receiving unit waits for the instruction, the stand-by process being executed in a performance mode whose performance level is the lowest among the plurality of performance modes.

10. The image processing device according to claim 1, wherein the plurality of functions includes at least two of a print function in which an image is printed on a recording medium based on image data, a scanner function in which image data is obtained by scanning an original, a copy function in which image data is obtained by scanning an original and an image is printed on a recording medium based on the scanned image data, a facsimile function in which facsimile data is received and transmitted, and a e-mail function in which an e-mail attached with image data obtained by scanning an original is transmitted.
